(19) United States
(12) Patent Application Publication
(10) Pub. No.: US 2011/0214508 A1
(43) Pub. Date: Sep. 8, 2011

(54) MONITORING THE STRUCTURAL INTEGRITY OF A WIND TURBINE BLADE

(76) Inventor: Mark Volanthen, Lockerley (GB)

(21) Appl. No.: 13/041,219

(22) Filed: Mar. 4, 2011

(30) Foreign Application Priority Data
Mar. 5, 2010 (GB) GB 1003686.1

(51) Int. Cl. G01L 1/24; G01L 1/00

(52) U.S. Cl. 73/800; 73/788

(57) ABSTRACT

A method of monitoring the structural integrity of a wind turbine blade 1 is disclosed. The blade 1 has at least two shell portions 2a, 2b, forming the outer surface of the turbine blade 1. At least one web member 3a, 3b connects the shell portions 2a, 2b in a transverse direction. The method comprises measuring a bending moment on the turbine blade 1 in a plane containing the longitudinal and transverse directions, measuring the transverse strain on the web member 3a, 3b at least one location, and comparing the measured transverse strain to an expected value for the transverse strain at the measured bending moment to provide an indication of debonding between the web member 3a, 3b and at least one shell portion 2a, 2b.

### CROSS-REFERENCE TO RELATED APPLICATION

This application claims the benefit under 35 U.S.C. §119(a) of Application No. GB 1003686.1 filed in the Intellectual Property Office of the United Kingdom on Mar. 5, 2010, the entire disclosure of which is incorporated herein by reference.

### FIELD OF THE INVENTION

This invention relates to the monitoring of wind turbines.

### BACKGROUND OF THE INVENTION

Blades for wind turbines are typically constructed of glass-reinforced plastics (GRP) on a sub-structure, which may be formed of wood, glass fibre, carbon fibre, foam or other materials. A typical wind turbine blade may have a length of between 20 and 60 metres or more. The plastics resin can be injected into a mould containing the sub-structure to form the outer surface of the blade. The blade may also be built up as a series of layers of fibre material and resin. In some cases, the fibre material is pre-impregnated with resin.

A typical wind turbine blade may have a length of between 20 and 60 metres or more. As the interior of the blade is generally hollow, a “floor” is provided within the blade proximate the hub-engaging end of the blade. The blade floor is a bulkhead about 0.5 metres to 2.5 metres into the blade that prevents service personnel falling into a blade while working in the hub.

One construction of a wind turbine blade takes the form of two blade halves held together by shear webs extending between the blade halves. With this construction, there is a risk that over an extended period of use the shear webs can debond from the blade halves and the strength of turbine blade can be impaired. In extreme cases, the turbine blade halves can become disconnected, which would be extremely dangerous. For this reason, it is common for the structural integrity of turbine blades to be checked manually at regular intervals for signs of debonding. However, such manual checks require the turbine to be stopped and service personnel to enter the blade structure, which may be in a remote or inhospitable location.

It is known, for example from U.S. Pat. No. 4,297,076, to provide the blades of a wind turbine with strain gauges and to adjust the pitch of portions of the blades in response to the bending moment on the blades measured by the strain gauges. Optical fibre strain sensors are known and WO 2004/056017 discloses a method of interrogating multiple fibre Bragg grating strain sensors along a single fibre. In the system of WO 2004/056017, Bragg gratings are defined in the optical fibre at spaced locations along the optical fibre. When the optical fibre is put under strain, the relative spacing of the planes of each Bragg grating changes, and thus the resonant optical wavelength of the grating changes. By determining the resonant wavelength of each grating, a strain measurement can be derived for the location of each grating along the fibre. Optical strain sensors operating on the principle of back scattering, which do not require discrete gratings along the fibre, are also known.

### BRIEF SUMMARY OF THE DISCLOSURE

Viewed from one aspect, the present invention provides a method of monitoring the structural integrity of a wind turbine blade. The blade comprises a shell extending in a longitudinal direction and defining the external shape of the turbine blade and at least one web member extending in a transverse direction from one internal surface of the shell to another. The method comprises: measuring a bending moment on the turbine blade in a plane containing the longitudinal and transverse directions; measuring the transverse strain on the web member at least one location; and comparing the measured transverse strain to an expected value for the transverse strain at the measured bending moment to provide an indication of debonding between the web member and the shell.

Thus, according to the invention, debonding between the web member and the shell can be detected. The method can be applied even while the turbine is in operation, because the strain sensors can operate even while the turbine is running, as is the case for other strain monitoring systems used in wind turbines.

In the context of the invention, “measuring” the bending moment and the transverse strain does not imply that an exact value for those quantities must be calculated and output, but merely that those properties of the turbine blade should be quantified to the extent necessary to carry out the invention.

The method may comprise measuring the transverse strain on the web member at a plurality of locations on the web member spaced in the longitudinal direction in order to provide an indication of the longitudinal extent of the debonding. Thus, a series of transverse strain sensors may be applied to the web member at intervals along its length. Typically the strain sensors will be arranged in the transverse direction close to the regions of potential debonding.

The expected value for the transverse strain may be determined by reference to a previous value for the transverse strain. Thus, the transverse strain from one or more strain sensors or pairs of strain sensors may be monitored over time, and deviations from the historical values may be used as an indication of debonding.

Alternatively or in addition, the expected value for the transverse strain may determined by reference to the transverse strain measured at another location on the web member. For example, where a longitudinal series of strain sensors is provided, the transverse strain measurement from neighbouring strain sensors may be used to determine the expected value of the transverse strain.

Measuring the bending moment on the turbine blade may comprise measuring strain in the longitudinal direction on opposite transverse sides of the turbine blade. Measuring strain in the longitudinal direction on opposite transverse sides of the turbine blade may comprise measuring strain in the longitudinal direction on the shell. Alternatively or in addition, measuring strain in the longitudinal direction on opposite transverse sides of the turbine blade may comprise measuring strain in the longitudinal direction at two locations on the web member spaced in the transverse direction.

Measuring the transverse strain on the web member may comprise measuring strain in a first direction at an acute angle to the transverse direction and in a second direction at substantially the same acute angle to the transverse direction but in the opposite sense and determining the sum or the difference in the strain measurements in the first and second directions. Similarly, the longitudinal strain on the web member may comprise measuring strain in a first direction at an acute angle to the transverse direction and in a second direction at substantially the same acute angle to the transverse direction but in the opposite sense and determining the sum or the difference in the strain measurements in the first and second directions. The acute angle may be substantially 45 degrees.

The invention extends to apparatus adapted to carry out the method of the invention. In particular, the apparatus may comprise a plurality of optical fibre strain sensors, in particular fibre Bragg grating strain sensors.

The invention also extends to a wind turbine blade provided with a plurality of strain sensors configured for monitoring the structural integrity of the turbine blade in accordance with the method of the invention. The shell of the wind turbine blade may comprise at least two shell portions, which together form the outer surface of the blade or a substantial part thereof.

### BRIEF DESCRIPTION OF THE DRAWINGS

An embodiment of the invention will now be described by way of example only and with reference to the accompanying drawings, in which:

FIG. 1 is a schematic cross-sectional view of a wind turbine blade; and

FIG. 2 is a schematic cross-sectional view the wind turbine blade along line B-B of FIG. 1.

### DETAILED DESCRIPTION

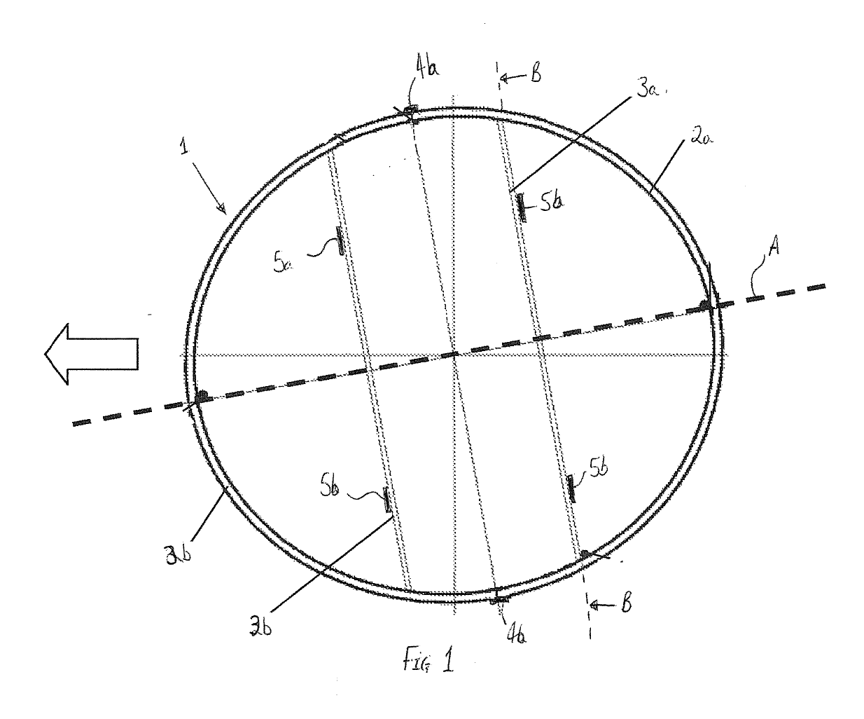

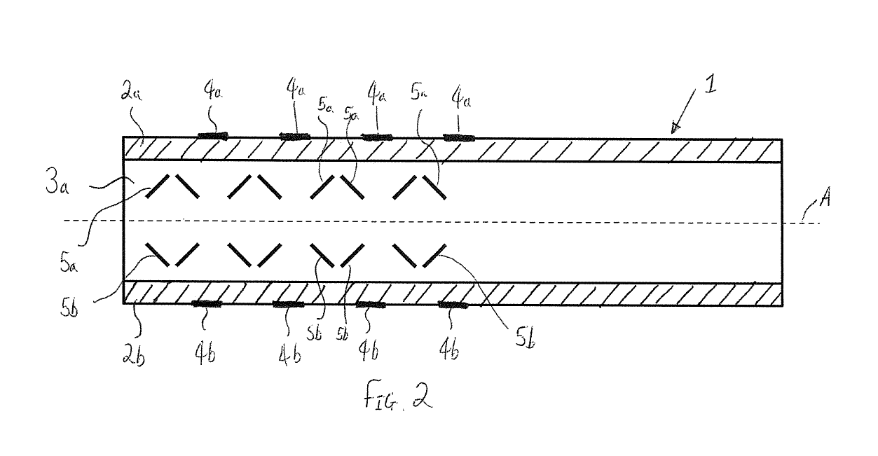

FIG. 1 shows the construction of a typical wind turbine blade 1. The view in FIG. 1 is a cross section of the base of the turbine blade 1 viewed from the hub of the wind turbine towards the tip of the turbine blade 1. The direction of travel of the turbine blade is indicated by the large arrow. The view in FIG. 2 is a cross-section of part of the blade 1 in the direction of the arrows B-B in FIG. 1.

The turbine blade 1 is constructed as a surface shell formed in two halves 2a, 2b that are connected by shear webs 3a, 3b. The dividing plane between the two halves 2a, 2b of the surface shell is indicated by the dashed line A in FIGS. 1 and 2. Bending strain sensors 4a, 4b are mounted to the outer surface of each half shell 2a, 2b. The strains sensors 4a, 4b are shown in Figures as mounted to the outer surface of the shells for simplicity, but the sensors 4a, 4b may alternatively by mounted to the inner surface of the shells.

Pairs of shear strain sensors 5a, 5b are mounted to each of the shear webs 3a, 3b. The series of upper sensors 5a are closest to one half shell 2a and the series of lower sensors 5b are closer to the lower blade half 2b. The shear strain sensors 5a, 5b are arranged in pairs with each sensor at 45 degrees to the longitudinal axis A of the blade 1. The shear strain sensors 5a, 5b form pairs with the orientation of one sensor mirroring the orientation of the other sensor about a transverse line of symmetry. In this way, the transverse shear strain on the sensor pair can be obtained by calculating the difference in the measured strains from the sensors of the pair. Similarly, the longitudinal (axial) strain on the sensor pair can be obtained by calculating the sum of the measured strains from the sensors of the pair. The sensors 4a, 4b, 5a, 5b take the form of fibre Bragg gratings formed in an optical fibre that forms the connection between the gratings. The optical fibre is connected, in use, to an instrument that supplies optical pulses to the optical fibre and evaluates the reflected light from the gratings as described in WO 2004/056017, for example.

With the arrangement of strain sensors shown in FIGS. 1 and 2, debonding between the shell halves 2a, 2b and the shear webs 3a, 3b can be detected in the following manner. In normal use, the turbine blade 1 flexes along its length and the instantaneous bending moment applied to the turbine blade 1 can be calculated from the difference in strain between pairs of longitudinal strain sensors 4a, 4b at the same longitudinal position along the blade 1. In the absence of debonding, bending of the blade 1 is transmitted to the shear webs 3a, 3b and generates shear strain in the shear webs 3a, 3b. This shear strain can be measured by the pairs of shear strain sensors 5a, 5b. For a given bending moment, there is an expected level of shear strain for each sensor 5a, 5b. However, if the bond between one of the shear webs 3a, 3b and one of the shell halves 2a, 2b starts to fail, the strain due to the bending of the shell half will not be transmitted effectively to the shear web and the shear strain will be reduced below the expected level. This can be used to identify debonding in use of the turbine blade.

The series of upper 5a and lower 5b shear strain sensors shown in FIG. 2 are capable of pinpointing a reduction in shear strain in the vicinity of one of the sensors, which is indicative of debonding local to that sensor.

In an alternative configuration, the longitudinal strain sensors 4a, 4b are not required and the longitudinal strain and hence the bending moment is determined from the sum of strain measurements from each pair of upper and lower shear strain sensors 5a, 5b.

In summary, a method of monitoring the structural integrity of a wind turbine blade 1 is disclosed. The blade 1 has at least two shell portions 2a, 2b, forming the outer surface of the turbine blade 1. At least one web member 3a, 3b connects the shell portions 2a, 2b in a transverse direction. The method comprises measuring a bending moment on the turbine blade 1 in a plane containing the longitudinal and transverse directions, measuring the transverse strain on the web member 3a, 3b at least one location, and comparing the measured transverse strain to an expected value for the transverse strain at the measured bending moment to provide an indication of debonding between the web member 3a, 3b and at least one shell portion 2a, 2b.

Throughout the description and claims of this specification, the words “comprise” and “contain” and variations of them mean “including but not limited to”, and they are not intended to (and do not) exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment, or example of the invention are to be understood to be applicable to any other aspect, embodiment, or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of monitoring the structural integrity of a wind turbine blade, the blade comprising a shell extending in a longitudinal direction and defining the external shape of the turbine blade and at least one web member extending in a transverse direction from one internal surface of the shell to another, wherein the method comprises:
measuring a bending moment on the turbine blade in a plane containing the longitudinal and transverse directions;
measuring the transverse strain on the web member at least one location; and
comparing the measured transverse strain to an expected value for the transverse strain at the measured bending moment to provide an indication of debonding between the web member and the shell.

2. A method as claimed in claim 1, comprising measuring the transverse strain on the web member at a plurality of locations on the web member spaced in the longitudinal direction in order to provide an indication of the longitudinal extent of the debonding.

3. A method as claimed in claim 1, wherein the expected value for the transverse strain is determined by reference to a previous value for the transverse strain.

4. A method as claimed in claim 1, wherein the expected value for the transverse strain is determined by reference to the transverse strain measured at another location on the web member.

5. A method as claimed in claim 1, wherein measuring the bending moment on the turbine blade comprises measuring strain in the longitudinal direction on opposite transverse sides of the turbine blade.

6. A method as claimed in claim 5, wherein measuring strain in the longitudinal direction on opposite transverse sides of the turbine blade comprises measuring strain in the longitudinal direction on the shell.

7. A method as claimed in claim 5, wherein measuring strain in the longitudinal direction on opposite transverse sides of the turbine blade comprises measuring strain in the longitudinal direction at two locations on the web member spaced in the transverse direction.

8. A method as claimed in claim 1, wherein measuring the transverse strain on the web member comprises measuring strain in a first direction at an acute angle to the transverse direction and in a second direction at substantially the same acute angle to the transverse direction but in the opposite sense and determining the difference in the strain measurements in the first and second directions.

9. A method as claimed in claim 8, wherein the acute angle is substantially 45 degrees.

10. An apparatus for monitoring the structural integrity of a wind turbine blade, the blade comprising a shell extending in a longitudinal direction and defining the external shape of the turbine blade and at least one web member extending in a transverse direction from one internal surface of the shell to another, wherein the apparatus is adapted to:
measure a bending moment on the turbine blade in a plane containing the longitudinal and transverse directions;
measure the transverse strain on the web member at least one location; and
compare the measured transverse strain to an expected value for the transverse strain at the measured bending moment to provide an indication of debonding between the web member and the shell.

11. An apparatus as claimed in claim 10, wherein the apparatus is adapted to measure the transverse strain on the web member at a plurality of locations on the web member spaced in the longitudinal direction in order to provide an indication of the longitudinal extent of the debonding.

12. An apparatus as claimed in claim 10, wherein the apparatus is adapted to determine the expected value for the transverse strain by reference to a previous value for the transverse strain.

13. An apparatus as claimed in claim 10, wherein the apparatus is adapted to determine the expected value for the transverse strain by reference to the transverse strain measured at another location on the web member.

14. An apparatus as claimed in claim 10, wherein the apparatus is adapted to measure the bending moment on the turbine blade by measuring strain in the longitudinal direction on opposite transverse sides of the turbine blade.

15. An apparatus as claimed in claim 14, wherein the apparatus is adapted to measure strain in the longitudinal direction on opposite transverse sides of the turbine blade by measuring strain in the longitudinal direction on the shell.

16. An apparatus as claimed in claim 14, wherein the apparatus is adapted to measure strain in the longitudinal direction on opposite transverse sides of the turbine blade comprises by measuring strain in the longitudinal direction at two locations on the web member spaced in the transverse direction.

17. An apparatus as claimed in claim 10, wherein the apparatus is adapted to measure the transverse strain on the web member by measuring strain in a first direction at an acute angle to the transverse direction and in a second direction at substantially the same acute angle to the transverse direction but in the opposite sense and determining the difference in the strain measurements in the first and second directions.

18. An apparatus as claimed in claim 17, wherein the acute angle is substantially 45 degrees.

19. An apparatus as claimed in claim 10 comprising a plurality of fibre Bragg grating strain sensors.

20. A wind turbine blade provided with a plurality of strain sensors configured for monitoring the structural integrity of the turbine blade in accordance with the method of claim 1.
